(19) United States
(12) Patent Application Publication
(10) Pub. No.: US 2008/0229346 A1
(43) Pub. Date: Sep. 18, 2008

(54) Disk Drive Unit Having an Air Flow Guide Element

(75) Inventor: Pippinus Maarten Robertus Wortelboer, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/996,607

(22) PCT Filed: Jul. 21, 2006
(86) PCT No.: PCT/IB06/52507

§ 371 Date: Jan. 24, 2008

(30) Foreign Application Priority Data
Jul. 28, 2005 (EP) 05106951.6

(51) Int. Cl. G11B 17/04; G11B 19/20; G11B 33/08; G11B 25/04

(52) U.S. Cl. 720/648; 720/652

(57) ABSTRACT

The invention relates to a disk drive unit for use in a device for reading and/or writing data on a disk. It comprises a housing (2, 5, 6) which accommodates a disk drive (3, 8-12, 14-17) and a tray (4, 7, 13) for disk transport into and from the housing (2, 5, 6). The tray (4, 7, 13) is movable through an opening (5) in a wall (6) of the housing (2, 5, 6) between an opened position and a closed position. The disk drive (3, 8-12, 14-17) comprises a turntable (8-10) to rotate the disk around a turntable axis (10) and a pickup unit (11), which is mounted to a sledge (11, 12, 14). The sledge (11, 12, 14) is movable within an opening (13) in the tray (4, 7, 13) substantially in radial direction with respect to the turntable axis (10) so as to allow the pickup unit (11) to read and/or write data on the disk. An air flow guide element (14-17) is engaged with the sledge (11, 12, 14) and adapted to cover at least a portion of the opening (13) in the tray (4, 7, 13), which is left next to the pickup unit (11) in the closed position of the tray (4, 7, 13), viewed in a direction parallel to the turntable axis (10). The air flow guide element reduces air flow disturbances below a rotating disk, thereby improving playability performance of the disk drive unit.

The present invention relates to a disk drive unit for use in a device for reading and/or writing data, including audio and/or video information, on a disk, comprising a housing which accommodates a disk drive and a tray for disk transport into and from the housing, said tray being movable through an aperture in a wall of the housing between an opened position and a closed position, said tray being partly outside the housing in the opened position for placing the disk on a bearing surface of the tray, and being substantially inside the housing in the closed position for allowing the disk drive to engage the disk, said disk drive comprising a turntable to rotate the disk around a turntable axis and a pickup unit which is mounted to a sledge and is positioned below the level of the bearing surface of the tray, the sledge being movable within an opening in the tray substantially in radial direction with respect to the turntable axis so as to enable the pickup unit to read and/or write data on the disk.

This type of disk drive units show a phenomenon of local out-of-plane deformation of disks at certain rotation speeds, which is caused by disturbed air flow around the disk in the disk drive unit. This phenomenon reduces playability and recording performance of a disk drive unit. Air flow disturbances happen, for example, near gaps between components which extend below the rotating disk. A typical gap is formed by the opening of the tray between the pickup unit and the tray in tangential direction with respect to the turntable axis when the tray is in the closed position. Some prior art disk drive units comprise pickup unit covers, forming a flat surface over components of the pickup unit. Such an unit is disclosed in U.S. Pat. No. 6,449,229 B1. The known covers, however, are intended for protecting the objective lens only.

It is an object of the present invention to provide a new disk drive unit having a means to reduce the above-mentioned air flow disturbances.

To obtain this object, the disk drive unit is provided with an air flow guide element, which is engaged with the sledge and adapted to cover at least a portion of the opening in the tray, which is left next to the pickup unit in the closed position of the tray, viewed in a direction parallel to the turntable axis.

The disk drive unit according to the invention is defined in claim 1.

In the closed position of the tray the air flow guide element covers at least a portion of the opening next to the pickup unit, which has the advantage that the air flow disturbance below the disk is reduced. Furthermore, the air flow guide element is engaged with the sledge. This has the advantage that the portion of the air flow guide element next to the pickup unit in a radial direction with respect to the turntable axis, viewed in a direction parallel to the turntable axis, is displaced together with the pickup unit, improving the air flow guidance at each radial position near the pickup unit and allowing displacement of the pickup unit without interference. Due to the inventive measure the playability performance of the disk drive unit is considerably improved.

According to claim 2 the air flow guide element substantially covers the portion of the opening in the tray, which is left between the pickup unit and the tray in tangential direction with respect to the turntable axis. This has the advantage that the gap between the pickup unit and the tray in tangential direction is bridged, hence reducing flow disturbances in direction of rotation.

According to claim 3 the air flow guide element has an upper surface which is substantially flush with the bearing surface of the tray. This has the advantage of smooth level transitions between the tray and pickup unit in tangential direction, which avoid air flow disturbances.

A flat surface as defined in claim 4 further improves the flow guidance.

Preferably the air flow guide element of the disk drive unit is made of light-weight material such as plastic or the like as defined in claim 5 so as to minimize the increase of inertia of the sledge.

According to claim 6 a preferred embodiment of the air flow guide element is a plate-shaped element, which comprises an opening, having a circumference substantially corresponding to the contour of the pickup unit, viewed in a direction parallel to the turntable axis. Such an embodiment is relatively simple to manufacture by using thin plates. The opening in the air flow guide element prevents the pickup unit from contacting it.

Claim 7 defines a preferred embodiment of securing means, which fix the air flow guide element to the sledge. The advantage of this embodiment is that it is a simple configuration to facilitate assembling of the air flow guide element to the sledge.

The invention also relates to an air flow guide element meant for a sledge of a disk drive unit according to the invention. This element is defined in claim 8. In mounted condition it substantially covers the portion of the opening in the tray, which is left between the pickup unit and the tray in tangential direction with respect to the turntable axis, hence reducing air flow disturbances in rotational direction below the rotating disk. Embodiments of the flow guide element are described in the claims 9 and 10.

The invention further relates to a device for reading and/or writing data, inclusive audio and/or video data, on a disk. The device according to the invention is defined in claim 11.

These and other aspects and advantages of the invention will be apparent from the following description with reference to the drawings.

In the drawings:

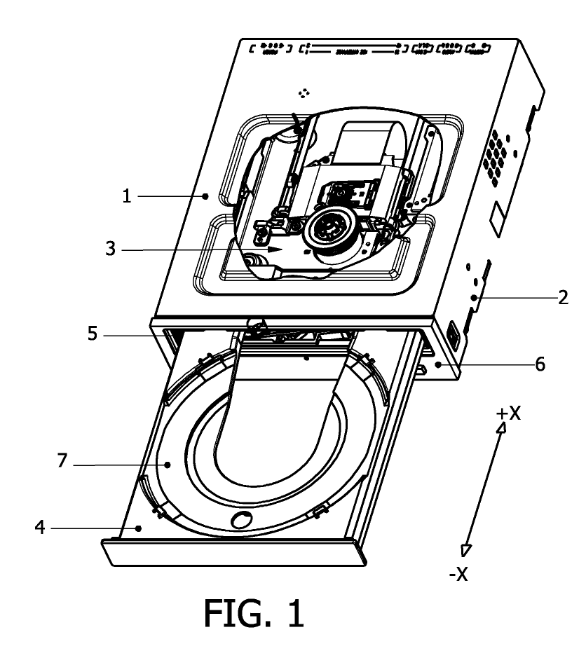

FIG. 1 is a perspective view of a housing comprising an embodiment of a disk drive unit according to the present invention.

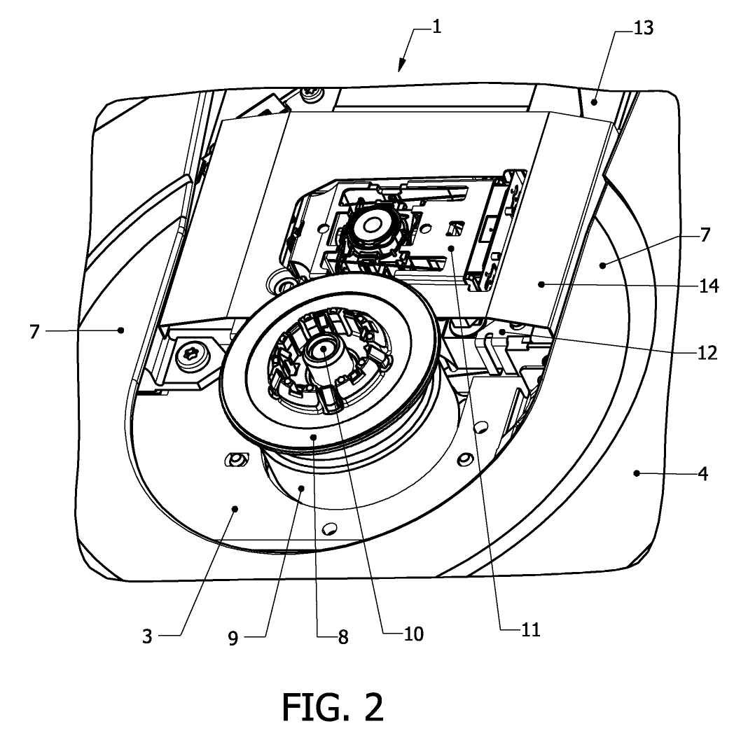

FIG. 2 is an enlarged perspective top view of a part of the disk drive unit of FIG. 1, in the interior of the housing.

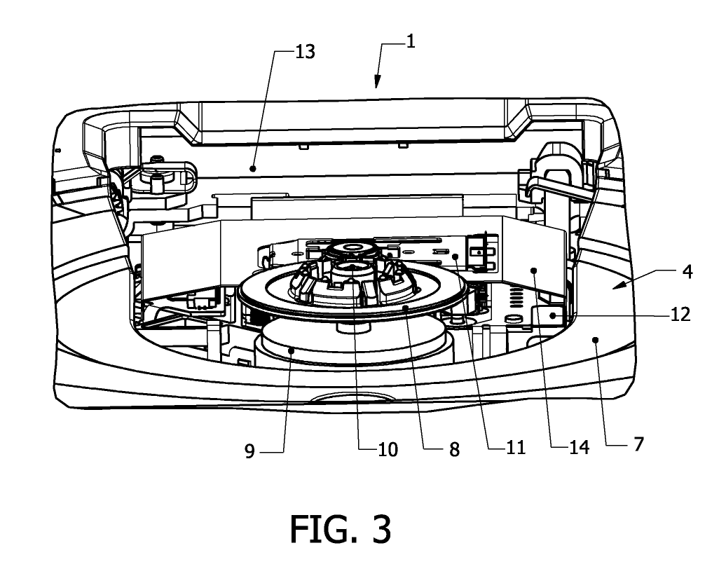

FIG. 3 is a perspective front view of the disk drive unit of FIG. 2.

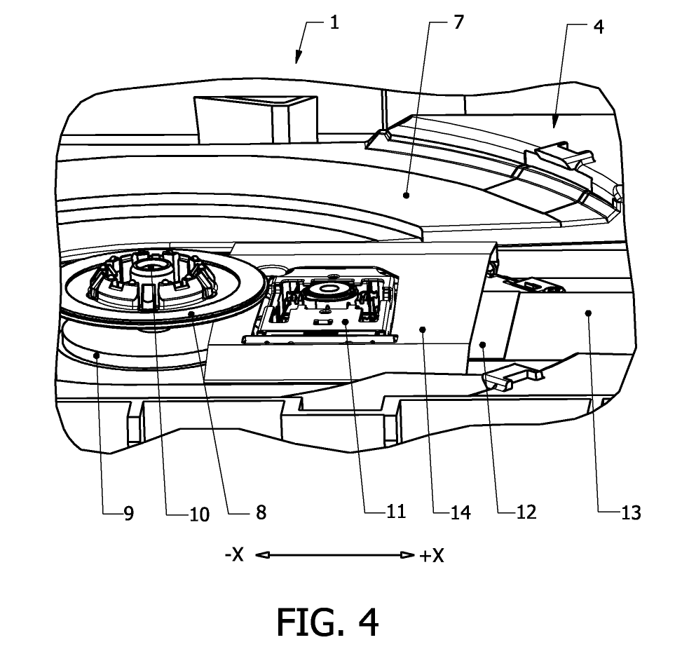

FIG. 4 is a perspective side view of the embodiment of FIG. 2.

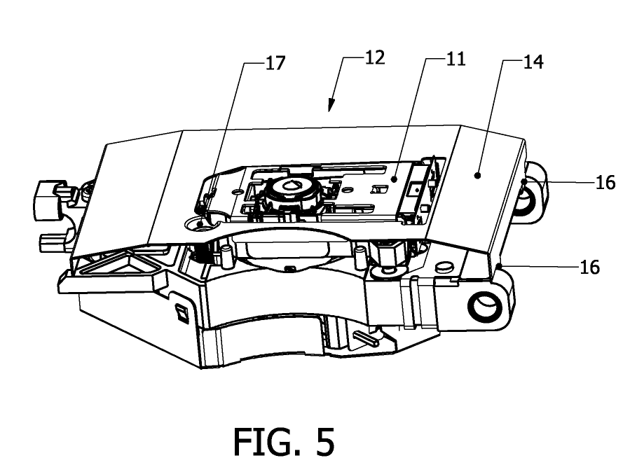

FIG. 5 is an enlarged perspective top view of a sledge of the disk drive unit of FIG. 2.

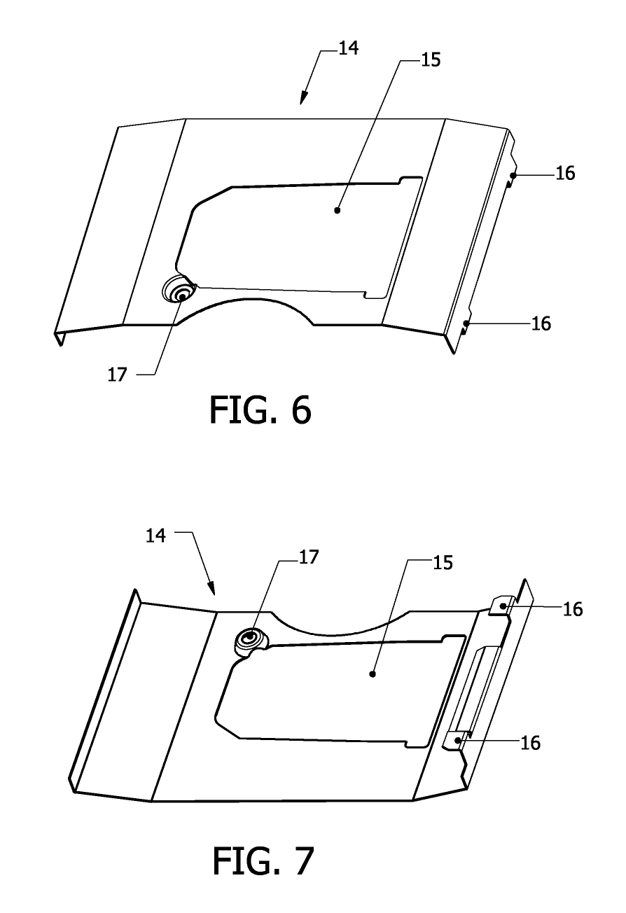

FIG. 6 is a perspective top view of an embodiment of an air guide element according to the present invention.

FIG. 7 is a perspective bottom view of the air guide element of FIG. 6.

FIG. 1 shows an embodiment of a disk drive unit 1 according to the invention. The disk drive unit is used for reading and/or writing data on a disk (not shown). It comprises a housing 2 which accommodates a disk drive 3 and a tray 4.

The tray 4 can transport a disk into and from the housing 2 through an aperture 5 in a side wall 6 of the housing 2. The tray 4 is movable by a driving assembly (not shown) between an opened position and a closed position. Displacement to the closed position is in +X direction; displacement to the opened position is in opposite direction (−X direction). In the opened position the tray 4 partly projects from the housing 2. In this position a disk can be placed on a bearing surface 7 of the tray 4. In the closed position the tray 4 is substantially inside the housing 2. In this position the disk drive 3 is allowed to engage a disk, if one is placed on the tray 4.

With reference to FIGS. 2-4 the disk drive 3 comprises a turntable 8, which has a fixed position in horizontal direction with respect to the housing 2. In the closed position of the tray 4 the turntable 8 can engage a disk, for example by moving the turntable towards the disk. In operation, the turntable 8 is driven by an electric motor 9 and rotates a disk around a turntable axis 10. Furthermore, the disk drive 3 comprises a pickup unit 11, which is mounted to a sledge 12. The sledge 12 can be displaced with respect to the turntable axis 10 mainly in two opposite directions +X and −X. This displacement enables the pickup unit 11 to read or write data on a disk when the disk drive unit 1 is in operation.

The tray 4 has an opening 13 in order to enable the sledge 12 to be displaced in +X and −X direction. A portion of the opening 13 in the tray 4 is covered by an air flow guide element 14. The air flow guide element 14 bridges the gap between the pickup unit 11 and the tray 4 in direction of rotation, and also a portion of the opening in the tray 4 next to the pickup unit in +X and −X direction. The air flow guide element 14 is engaged with the sledge 12 and extends next to the pickup unit 11, viewed in a direction parallel to the turntable axis 10. This means that the air flow guide element 14 is displaced together with the pickup unit 10 in +X and −X direction within the opening 13 of the tray 4. When the sledge 12 has a position close to the turntable 8 the air flow guide element 14 can partly extend below the turntable 8, see FIG. 4. In operation, the rotational air flow below the disk is smoothly guided over the upper surface of the air flow guide element 14.

The air flow guide element 14 has a substantially flat upper surface in order to reduce disturbance of the air flow between a rotating disk and the upper surface of the air flow guide element 14. The upper surface of the air flow guide element 14 is substantially flush with the bearing surface 7 of the tray 4, see FIG. 4. This configuration results in a smooth transition from the bearing surface 7 of the tray 4 to the upper surface of the air flow guide element 14 in a tangential direction with respect to the turntable axis 10. As a consequence, disturbances of the air flow below a rotating disk near the pickup unit will be minimized. In the embodiment of the FIGS. 2-5 the upper surface of the air flow guide element 14 has the highest vertical level next to the pickup unit 11, viewed in a direction parallel to the turntable axis 10. The level of the upper surface of the air flow guide element 14 substantially equals the upper level op the pickup unit 11. The level of the upper surface may gradually decrease in the direction of the tray in tangential direction with respect to the turntable axis 10. The reason for this configuration is that the vertical position of the upper surface of the pickup unit 11 is slightly higher than the level of the bearing surface 7 of the tray 4. This configuration enables a smooth flow guidance. If the upper surface of the pickup unit 11 has the same level as the level of the bearing surface 7 of the tray 4, for example, the level of the upper surface may be entirely flat.

The air flow guide element 14 is preferably a plate-shaped element made of light-weight material such as plastic or the like so as to minimize its weight. This is important because of avoiding excessive increase of inertia forces of the sledge 12 when it is moving.

FIGS. 6 and 7 show the air flow guide element 14 in more detail. It has an opening 15 in the centre which has a similar shape as and slightly larger dimensions than the outer circumference of the pickup unit 11, viewed in a direction parallel to the turntable axis 10. This enables the air flow guide element 14 to be mounted to the sledge without contacting the pickup unit 11. In the embodiment of FIGS. 6 and 7 the air flow guide element 14 has securing means 16, which comprise two projections 16 and a fixing element (not shown) to be moved through a hole 17 in the air flow guide element 14. The projections 16 are clamped behind a projection (not shown) on the sledge 12, thereby clamping one end portion of the air flow guide element 14 to the sledge 12. The fixing element may be a screw which can be screwed into the sledge 12 through the hole 17 in the air flow guide element 14, in order to fix it at the opposite end.

From the foregoing it will be clear that the invention provides a disk drive unit having an air flow guide element, which reduces air flow disturbances below a rotating disk nearby the pickup unit.

The invention is not restricted to the above-described embodiment as shown in the drawings, which can be varied in several ways without departing from the scope of the invention. The air flow guide member may cover a portion of the pickup unit as well. Furthermore, there are several possible alternatives for securing the air flow guide element to the sledge, such as a clamping connection only or applying an adhesive like glue.

In general it is noted that, in this application, the expression “comprising” does not exclude other elements, and “a” or “an” does not exclude a plurality. A single processor or unit may fulfil the functions of several elements in the appended claims. Reference signs in the claims shall not be construed as limiting the scope thereof.

1-11. (canceled)

12. Disk drive unit (1-17), particularly meant for use in a device for reading and/or writing data on a disk, comprising a housing (2, 5, 6) which accommodates a disk drive (3, 8-12, 14-17) and a tray (4, 7, 13) for disk transport into and from the housing (2, 5 6), said tray (4, 7, 13) being movable through an aperture (5) of the housing (2, 5, 6) between an opened position and a closed position, said tray (4, 7, 13) being at least partly outside the housing (2, 5, 6) in the opened position for placing the disk on a bearing surface (7) of the tray (4, 7, 13), and being substantially inside the housing (2, 5, 6) in the closed position for allowing the disk drive (3, 8-12, 14-17) to engage the disk, said disk drive (3, 8-12, 14-17) comprising a turntable (8-10) for rotating the disk around a turntable axis (10) and a pickup unit (11), which pickup unit is mounted to a sledge (11, 12, 14), characterized in that the sledge is movable within an opening (13) in the tray (4, 7, 13) substantially in radial direction with respect to the turntable axis (10), wherein an air flow guide element (14-17) is engaged with the sledge (11, 12, 14) and at least covers the portion of the opening (13) in the tray (4, 7, 13), which is left between the pickup unit (11) and the tray (4, 7, 13) in tangential direction with respect to the turntable axis (10) in the closed position of the tray (4, 7, 13).

13. Disk drive unit (1-17) according to claim 12, wherein the air flow guide element (14-17) has an upper surface, which is substantially flush with the bearing surface (7) of the tray (4, 7).

14. Disk drive unit according to claim 13, wherein the upper surface is substantially flat.

15. Disk drive unit (1-17) according to claim 12, wherein the air flow guide element (14-17) is made of light-weight material such as plastic or the like.

16. Disk drive unit (1-17) according to claim 12, wherein the air flow guide element (14-17) is plate-shaped and comprises an opening (15), having a circumference substantially corresponding to the contour of the pickup unit (11), viewed in a direction parallel to the turntable axis (10).

17. Disk drive unit (1-17) according to claim 12, wherein the air flow guide element (14-17) provides securing means (16) so as to fix the air flow guide element (14-17) to the sledge, which securing means (16) preferably comprise at least a projection (16) at one end portion of the air flow guide element (14-17), which clamps behind a projection on the sledge (11, 12, 14), and a fixing element which secures the air flow guide element (14-17) to the sledge (11, 12, 14), wherein the fixing element is preferably a screw, which is screwed in the sledge (11, 12, 14) through a hole (17) in the air flow guide element (14-17).

18. Air flow guide element (14-17) for a sledge (11, 12, 14) of a disk drive unit (1-17) according to claim 12, which is plate-shaped and comprises an opening (15), having a circumference substantially corresponding to the contour of the pickup unit (11), viewed in a direction parallel to the turntable axis (10), said air flow guide element (14-17) in mounted condition substantially covers the portion of the opening (13) in the tray (4, 7, 13), which is left between the pickup unit (11) and the tray (4, 7, 13) in tangential direction with respect to the turntable axis.

19. Air flow guide element (14-17) according to claim 18, which has a flat upper surface and comprises securing means so as to fix the air flow guide element (14-17) to the sledge (11, 12, 14) such that the upper surface is substantially flush with the bearing surface of the tray (4, 7, 13).

20. Air flow guide element (14-17) according to claim 19, wherein the securing means comprise at least a projection at one end portion of the air flow guide element (14-17), which clamps behind a projection on the sledge (11, 12, 14), and a fixing element which secures the air flow guide element (14-17) to the sledge (11, 12, 14), wherein the fixing element is preferably a screw which is screwed in the sledge (11, 12, 14) through a hole in the air flow guide element (14-17).

21. Device for reading and/or writing data on a disk, provided with the disk drive unit according to claim 12.
